(19) United States
(12) Patent Application Publication
(10) Pub. No.: US 2008/0219527 A1
(43) Pub. Date: Sep. 11, 2008

(54) Cardiac Region Detection From Motion Analysis of Small Scale Reconstruction

(75) Inventors: Guy Lavi, Kfar Vitkin (IL); Jonathan Lessick, Haifa (IL)

Correspondence Address: PHILIPS INTELLECTUAL PROPERTY & STANDARDS, 595 MINER ROAD, CLEVELAND, OH, 44143, US

(73) Assignee: Koninklijke Philips Electronics N. V., Eindhoven (NL)

(21) Appl. No.: 11/996,800

(22) PCT Filed: Jul. 17, 2006
(86) PCT No.: PCT/IB06/52434

§ 371 Date: Jan. 25, 2008

Related U.S. Application Data
(60) Provisional application No. 60/702,529, filed on Jul. 26, 2005.

(51) Int. Cl. G06K 9/00; G06T 7/00

(52) U.S. Cl. 382/128; 345/420; 600/424

(57) ABSTRACT

A diagnostic imaging system (10) images overlapping cyclically moving and stationary regions of a subject. A low resolution reconstruction processor (50) reconstructs acquired data into a series of consecutive low resolution volumetric image representations. A motion region determining processor (70) determines a boundary of the moving region from the consecutive low resolution volumetric image representations. A high resolution reconstruction processor (60) reconstructs the acquired data into a high resolution volumetric image representation. A stationary region removing processor (84) removes stationary region image data from the high resolution volumetric image representation, which stationary region image data lies exterior to the moving region boundary. A display (86) displays the high resolution volumetric image representation.

The present application relates to the diagnostic imaging arts. It finds particular application in cardiac computed tomography imaging of a subject, and will be described with particular reference thereto. However, it may also find application in other types of computed tomography imaging, single photon emission computed tomography (SPECT), positron emission tomography (PET), magnetic resonance imaging (MRI), three-dimensional x-ray imaging, and the like.

In general, a computed-tomography system comprises an x-ray source and an x-ray detector which rotates around an object to be examined. From several orientations, the object is irradiated with an x-ray beam from the x-ray source. The x-ray detector receives x-radiation that has passed through the object at the respective orientations and forms an attenuation profile for the orientation at issue. The attenuation profiles represent the attenuation of incident x-rays in the object due to and absorption or scattering of x-rays along the path of the x-rays through the object at the orientation at issue.

Helical cardiac cone beam images are reconstructed using phase selective algorithms. Typically, particular phases of the heart are chosen for cardiac image generation. Only data acquired close in time to the selected phases, i.e., the points in time corresponding to the same cardiac phase, but in different heart cycles, are used simultaneously in a multi-slice reconstruction process. Depending on the scan parameters, the patient's heart rate and its variability, the cardiac gating window width and position, a variable number of cycles is used for reconstruction of each of the voxels. Typically, the voxels are reconstructed from all available rays over all cardiac cycles which pass through a given voxel, i.e. an illumination window.

The detection of the cardiac region in a CT chest scan is the primary post-processing task required to properly visualize the heart in 3D images. This task is typically performed manually in post-processing domain. That is, a 3D volumetric image of a torso section including the heart is generated. To analyze the image, the radiologist performs a “cage removal” process. In this post-processing process, the radiologist sections the previously reconstructed image to cut off ribs, lungs, and other non-cardiac tissue leaving a volume image of just the cardiac tissue of interest. This is a labor intensive process.

Some techniques of the cardiac ROI detection are based on tissue segmentation from a single reconstruction and include known algorithms such as the Active contour model, Threshold determination by histogram analysis, and a Fourier-based active contour approach. However, such techniques suffer from significant case-dependent variability in performance, are applied in post processing operations on high resolution data sets, and often require manual correction. In addition, these techniques are time-consuming.

The present invention contemplates a method and apparatus that overcomes the aforementioned limitations and others.

According to one aspect of the present application, a diagnostic imaging system for imaging overlapping cyclically moving and stationary regions of a subject is disclosed. A low resolution reconstruction processor reconstructs acquired data into a series of consecutive low resolution volumetric image representations. A motion region determining processor determines a boundary of the moving region from the consecutive low resolution volumetric image representations. A high resolution reconstruction processor reconstructs the acquired data into a high resolution volumetric image representation. A stationary region removing processor removes stationary region image data from the high resolution volumetric image representation, which stationary region image data lies exterior to the moving region boundary. A display displays the high resolution volumetric image representation.

According to another aspect of the present application, a method for imaging overlapping cyclically moving and stationary regions of a subject, which stationary region image data lies exterior to the moving region boundary, is disclosed. Acquired data is reconstructed into a series of consecutive low resolution volumetric image representations. A boundary of the moving region is determined from the consecutive low resolution volumetric image representations. Acquired data is reconstructed into a high resolution volumetric image representation. The stationary region image data is eliminated from the high resolution volumetric image representation. The volumetric image representation is displayed.

One advantage of the present application resides in automatic isolation of the cardiac region of interest before reconstruction.

Another advantage resides in improved resolution of cardiac images.

Another advantage resides in substantially real time cardiac imaging with surrounding tissues already removed.

Numerous additional advantages and benefits will become apparent to those of ordinary skill in the art upon reading the following detailed description of the preferred embodiments.

The invention may take form in various components and arrangements of components, and in various process operations and arrangements of process operations. The drawings are only for the purpose of illustrating preferred embodiments and are not to be construed as limiting the invention.

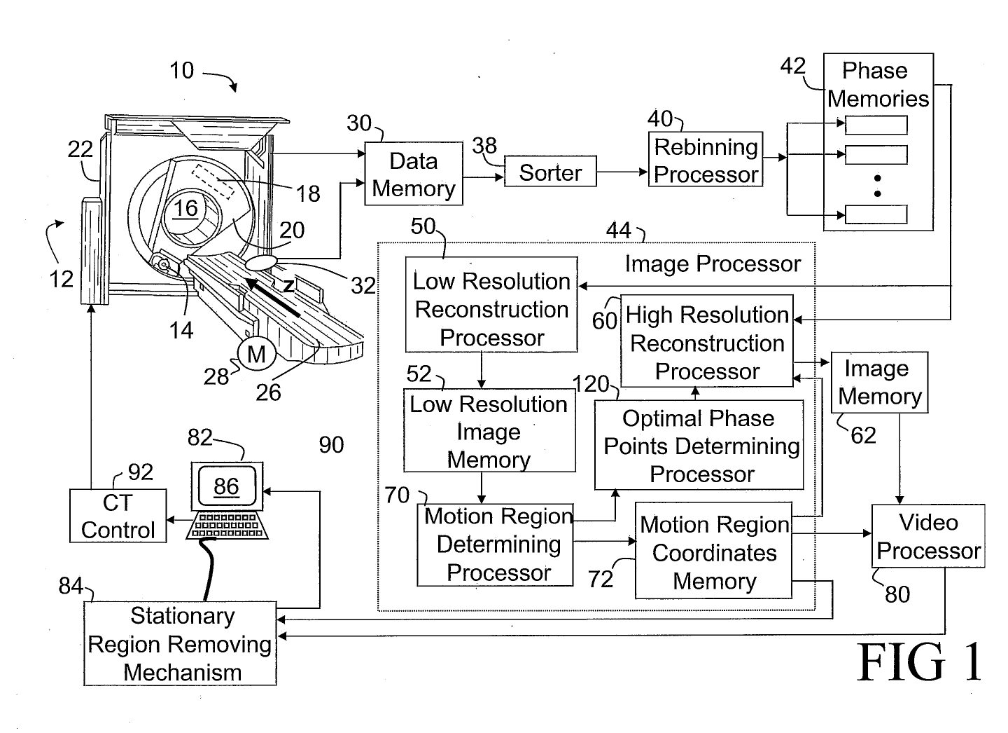

FIG. 1 diagrammatically shows a computed tomography imaging system; and

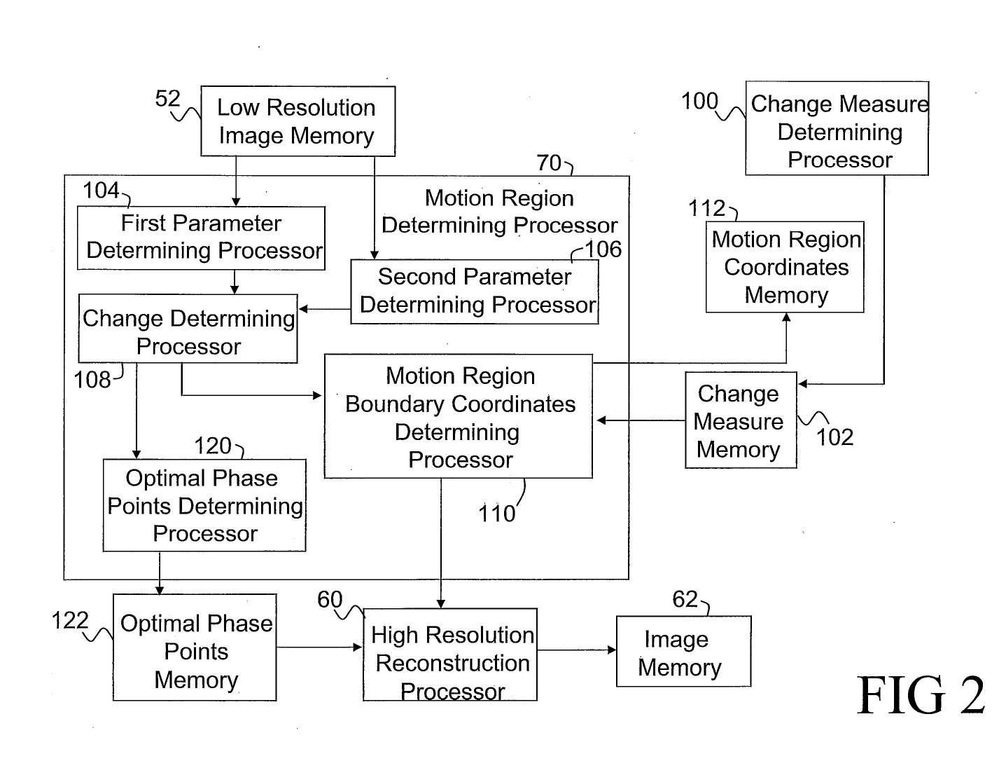

FIG. 2 diagrammatically shows a detailed portion of the computed tomography imaging system.

With reference to FIG. 1, an imaging system 10 includes a computed tomography scanner 12 having a radiation source 14 that produces a radiation beam, preferably a cone or wedge beam, directed into an examination region 16. The radiation beam interacts with and is partially absorbed as it traverses a region of interest of an imaging subject disposed in the examination region 16, producing spatially varying absorption of the radiation as it passes through the examination region. A radiation detector 18, preferably a two-dimensional detector, detects the absorption-attenuated radiation after it passes through the examination region 16. The path between the source 14 and each of radiation detection elements of the detector 18 is denoted as a ray.

Preferably, the radiation source 14 produces a cone-beam of x-rays. The radiation source 14 and the detector 18 are preferably mounted in oppositely facing fashion on a rotating gantry 20 so that the detector 18 continuously receives x-rays from the radiation source 14. As the source 14 and the detector 18 rotate continuously about the examination region 16 on the rotating gantry 20, views are acquired over a plurality of rotations. Each view or two-dimensional array of data represents a cone of rays having a vertex at the source 14 collected by a concurrent sampling of the detection elements of the detector 18. In helical cone beam computed tomography, a subject support or bed 26 is linearly moved in an axial or Z direction by a motor drive 28.

Optionally, cone beam computed tomography projection data are acquired over several rotations either (i) with the subject support 26 being stationary during each axial scan and stepped linearly between axial scans or (ii) with the subject support moving continuously to define a helical trajectory. The outputs of the detection elements of the radiation detector 18 are converted to electronic acquired integrated attenuation projection values μdₒ that are stored in a data memory 30. Each projection datum μdₒ corresponds to a line integral of attenuation along a line from the radiation source 14 to a corresponding one of the detection elements of the detector 18.

For typical cone-beam geometries, the line integral index typically corresponds to a detector element used to measure the reading. It is contemplated, however, that the line integral index may lack a direct correspondence with detector element number. Such a lack of direct correspondence can result, for example, from interpolation between re-binned projections.

For a source-focused acquisition geometry in a multi-slice scanner, readings of the attenuation line integrals or projections of the projection data set stored in the data memory 30 can be parameterized as P(α,β,n), where α is the source angle of the radiation source 14 determined by the position of the rotating gantry 20, β is the angle within the fan (β∈[−Φ/2, Φ/2] where Φ is the fan angle), and n is the detector row number.

A cardiac monitor 32 monitors the patient's cardiac cycle and detects phase points 34, typically relative to the R-wave of each cycle, i.e. in each R-R interval. The position of the phase point 34 is selected by the clinician according to the motion characteristic of the heart and the required diagnostic information or determined automatically as discussed in detail below. A sorting means 38 sorts the attenuation data into data sets collected during each of the selected cardiac phases, i.e. cardiac phase specific data sets. In one embodiment, a re-binning processor 40 re-bins the cardiac phase specific data from cone to parallel beam geometry into a set of parallel views. Each view contains equidistant π-lines, where a π-line is defined as a line integral that is contained in the axial plane, i.e., perpendicular to the rotation axis, intersecting the scan FOV and is characterized by the canonic coordinates θ_{π}, 1, where θ_{π} is an angle of propagation ∈[0, π), and 1 is a distance from an iso-center. Particularly for cardiac phases defined by a short temporal window, the data for one cardiac phase corresponds to data collected over short arc segments in each of a plurality of rotations and cardiac cycles. The arc segments of data individually are too small to be a full data set. To generate a full data set, data is collected over several cardiac cycles and, if necessary, interpolated. The cardiac phase specific data sets are stored in corresponding phase memories 42.

An image processor 44 reconstructs the projection data into 3D image representation. More specifically, a low resolution reconstruction processor 50 processes the projected data for selected cardiac phases into a series of low resolution images which are stored in a low resolution image memory 52. A high resolution reconstruction processor 60 performs a filtered backprojection or other reconstruction of the projection data into corresponding three-dimensional image, which are stored in an image memory 62. As discussed in detail below, a motion region determining processor or algorithm 70 determines a moving region or a heart region in the volume of data and stores coordinates of a moving or heart region boundary into a motion region coordinates memory 72. The high resolution reconstruction process can expedite the reconstruction process by reconstructing only the cardiac regions.

A video processor 80 processes some or all of the contents of the image memory 62 to create a human-viewable image representation such as a three-dimensional rendering, a selected image slice, a maximum intensity projection, a CINE animation, or the like. A series of images along with the heart region coordinates are received at a workstation 82, which is preferably a personal computer, a laptop computer, or the like. The workstation 82 includes appropriate hardware and software for image processing and viewing. For example, the workstation 82 includes a stationary region removing means or algorithm or mechanism 84 which, based on the received heart region coordinates, automatically removes the extraneous tissue, such as a rib cage and lungs, that surrounds and conceals the heart from the viewer. Of course, it is contemplated that the extraneous tissue removal can be initiated by the user. The human-viewable image representation of the heart including coronary arteries without the extraneous tissue is displayed on a display 86. Such automated process helps the viewer to visualize the isolated heart immediately instead of manually removing the extraneous tissue.

Optionally, selected contents of the image memory 62 are printed on paper, stored in a non-volatile electronic or magnetic storage medium, transmitted over a local area network or the Internet, or otherwise processed. Preferably, a radiologist or other operator controls the computed tomography imaging scanner 12 via a keyboard, mouse, touch screen or other input means 90 to program a scan controller 92 to set up an imaging session, modify an imaging session, execute an imaging session, monitor an imaging session, or otherwise operate the scanner 12.

With continuing reference to FIG. 1 and further reference to FIG. 2, the low resolution reconstruction processor 50 processes the projection data into a series of subsequent low resolution three dimensional images of the heart. For example, the low resolution reconstruction processor 50 processes the projection data corresponding to two opposite phases of the heart, e.g. 0% and 50% of the cardiac cycle. It is also contemplated that the low resolution reconstruction processor 50 can process the projection data of different multiple phase points which cover part of or substantially the entire cardiac cycle. The motion region determining processor or algorithm 70 determines a boundary of the moving region of the heart by comparing the low resolution images of selected subsequent phases of the heart. More specifically, for each phase, a change measure determining processor or algorithm 100 determines a measure of change between phases such as a change in voxel intensity which corresponds to a change between a first aspect or parameter of a first image and a second aspect or parameter of the second image. The first and second parameters are prespecified and of similar nature such as voxels intensity values. Other examples of the change measure are a correlation measure, and a function that expresses an expected cardiac motion through the cycle. For example, the change measure may be set by the user before the scan. The change measure is stored in a change measure memory 102. A first parameter determining processor 104 determines the first parameter such as a voxel intensity value for each voxel of the first image. A second parameter determining processor 106 determines a second parameter such as a voxel intensity value for each voxel of the second image. A change determining processor or algorithm 108 compares corresponding first and second parameters of the first and second consecutive images to determine a change in values of the first and second parameters. In an exemplary change determination, the two images are subtracted. Stationary tissue substantially zeros out while tissue that moved has non-zero values. A motion region boundary coordinates determining processor or algorithm 110 compares each determined difference value between the first and second parameters of consecutive reconstructed images with the change measure to determine where the change is the greatest and where the change is the lowest. In this manner, the motion region boundary coordinates determining processor 110 establishes the boundary of the heart region, e.g., the boundary between the moving and stationary regions of the data volume. Coordinates of the heart region are determined as coordinates of the boundary between the moving and stationary regions of the data volume. The heart region coordinates are stored in a motion or heart region coordinates memory 112.

In post-processing examples, the stationary region removing means or algorithm or mechanism 84 receives the heart region coordinates along with corresponding reconstructed images and removes the extraneous tissue that surrounds and conceals the heart from the viewer. In one embodiment, the stationary region removing algorithm or mechanism 84 removes the extraneous tissue automatically when the user opens up the reconstructed images for display. In another embodiment, the stationary region removing mechanism 84 removes the extraneous tissue automatically upon user's initiation. For example, the workstation 82 may have a user interface which allows user to select the removal of the extraneous tissue by selecting a corresponding option. In this manner, only voxels within the maximum motion region are retained. The remaining voxels are discarded for the image of the isolated heart to be automatically displayed, without a need for the manual removal of the rib cage and other extraneous tissue. The technique is performed before or during the reconstruction, or, at least, prior to the post-processing stage.

In a preprocessing embodiment, the edge coordinates of the heart are determined from low resolution pilot scans. The determined edges in each selected cardiac phase are communicated to the high resolution processor 60 which focuses reconstruction resources on the identified cardiac region. In one example, only the cardiac region is reconstructed. In another, the cardiac region is weighted more heavily than the surrounding regions. Optionally, the boundary is also communicated to the scan control 92 which adjusts scan parameters, e.g. cone angle, in accordance with the cardiac boundaries.

In one embodiment, the motion region determining processor 70 determines a time period for each segment of the moving region within the cardiac cycle during which time period each segment is motionless, e.g. the motion region determining processor determines when and which areas of the heart are at rest. In such motionless areas, the change between reconstructed images in two adjacent phase or temporal windows is negligent. An optimal phase points determining processor or algorithm 120 determines optimal phase points which lie in the motionless segments of the moving region. For example, a quiet phase at right anterior surface of the heart for the right coronary artery, the left anterior surface for the left anterior descending artery, and the left posterior surface for the circumflex artery and its branches can be identified. The stationary edge segments can be determined from earlier and later phase windows in which the stationary edge segments last or next move.

Although the high and low resolution processors 50, 60 have been separately labeled for ease of explanation, it is to be appreciated that common hardware can perform both functions. Indeed, substantially all processing functions can be performed by a suitably programmed computer. Also, although described with reference to CT imaging, the technique is applicable to other imaging modalities.

In Summary:

1. a. Low-resolution reconstruction of retrospectively gated CT data set is performed. Minimum requirement 2 opposite phases e.g. 0% and 50% of the cardiac cycle. May use multiple reconstructions when simultaneously calculating “motion maps” for optimal phase detection. This process should be applied after scanning the patient and before loading the reconstructed data sets to the workstation for analysis.
b. For MRI and EBCT compare images acquired at 2 or more phases through the cardiac cycle.

2. For each phase acquired or reconstructed, calculate a measure of change between different phases (may be a simple change in value, a measure of correlation or a simple function simulating expected cardiac motion through a cycle).

3. Identify voxels that appear to exhibit cardiac motion characteristics.

4. Remove isolated elements.

5. Identify an outer confluent layer or surface that defines the outer ROI of the heart.

6. Double check integrity of algorithm by confirming similarity to lung-heart interface.

7. May now apply full motion mapping to identify quiet phase at right anterior surface of heart for the right coronary artery, the left anterior surface for the left anterior descending artery and the left posterior surface for the circumflex artery and its branches.

8. Record the details of the analysis in an accessory file to be used when the user loads the data sets.

9. On obtaining confirmation from the user, the results of the analysis can be used
a. to aid in visualization and image analysis; and
b. to determine what portion of the data-set to store permanently e.g. the full anatomical data set is required for only one temporal phase. For the remaining phases, only the cardiac ROI need be stored.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A diagnostic imaging system for imaging overlapping cyclically moving and stationary regions of a subject, comprising:
a low resolution reconstruction processor, which reconstructs acquired data into a series of consecutive low resolution volumetric image representations;
a motion region determining processor, which determines a boundary of the moving region from the consecutive low resolution volumetric image representations;
a high resolution reconstruction processor, which reconstructs the acquired data into a high resolution volumetric image representation;
a stationary region removing processor, which removes stationary region image data from the high resolution volumetric image representation, which stationary region image data lies exterior to the moving region boundary; and
a display for displaying the high resolution volumetric image representation.

2. The system as set forth in claim 1, wherein the stationary region removing processor removes the stationary region image data from the high resolution volumetric image representation automatically prior to displaying.

3. The system as set forth in claim 1, further including:
a motion region boundary coordinates determining processor which determines coordinates of the moving region boundary; and
a motion region coordinates memory, into which the motion region boundary coordinates determining processor loads coordinates of the moving region boundary, and from which the coordinates of the moving region boundary are loaded into the stationary region removing processor along with the high resolution volumetric image representation.

4. The system as set forth in claim 1, wherein the low resolution reconstruction processor reconstructs images in each of a plurality of phases of a pulsating organ.

5. The system as set forth in claim 1, wherein the moving region includes a cardiac region.

6. The system as set forth in claim 5, further including:
a sorter for sorting the acquired data into data sets collected during each of a plurality of selected cardiac phases.

7. The system as set forth in claim 1, wherein the low resolution processor reconstructs multiple consecutive low resolution volumetric image representations and the motion region determining processor determines a time period for each segment of the moving region within the cycle during which time period each segment is motionless.

8. The system as set forth in claim 1, further including one of a CT scanner, magnetic resonance scanner, and a nuclear camera for acquiring the acquired data.

9. A method for imaging overlapping cyclically moving and stationary regions of a subject, which stationary region image data lies exterior to the moving region boundary, comprising:
reconstructing acquired data into a series of consecutive low resolution volumetric image representations;
determining a boundary of the moving region from the consecutive low resolution volumetric image representations;
reconstructing acquired data into a high resolution volumetric image representation;
eliminating the stationary region image data from the high resolution volumetric image representation; and
displaying the volumetric image representation.

10. The method as set forth in claim 9, wherein the step of the stationary region removal includes:
removing the stationary region image data from the high resolution volumetric image representation automatically prior to the step of displaying.

11. The method as set forth in claim 9, further including:
determining coordinates of the moving region boundary;
loading coordinates of the moving region boundary into a motion region coordinates memory; and
loading the coordinates of the moving region boundary into a workstation along with the high resolution volumetric image representation.

12. The method as set forth in claim 9, wherein the moving region includes a cardiac region.

13. The method as set forth in claim 12, further including:
sorting the acquired data into data sets collected during each of selected cardiac phases.

14. The method as set forth in claim 9, wherein the step of the low reconstruction includes:
reconstructing low resolution volumetric image representations in each of a plurality of selected cardiac phases.

15. The method as set forth in claim 14, wherein the step of the motion region determination includes:
comparing the low resolution volumetric image of each cardiac phase window with the low resolution volumetric image of at least one other cardiac phase window.

16. The method as set forth in claim 15, further including:
determining optimal phase points which lie in motionless segments of the moving region; and
reconstructing the high resolution image representation at the optimal phase points.

17. A diagnostic scanner for performing the steps of claim 9.

18. A method of diagnostic imaging comprising:
acquiring low resolution data;
generating a low resolution volumetric image of a moving region that moves with the cardiac cycle and a stationary region in at least two phases of a cardiac cycle;
determining an edge of the moving region that moves with the cardiac cycle in each phase by comparing the low resolution image in each phase with low resolution images in other phases;
acquiring high resolution data and one of:
reconstructing a high resolution image of only the moving region in each of a plurality of selected cardiac phases; and
reconstructing a high resolution image of the moving and stationary regions in each of the selected cardiac phases and removing regions on a stationary side of the determined edge.

19. The method as set forth in claim 18, wherein a low resolution volumetric image is generated in each selected cardiac phase.

20. A diagnostic scanner programmed to perform the method of claim 18.
